(19) United States
(12) Patent Application Publication
(10) Pub. No.: US 2017/0203914 A1
(43) Pub. Date: Jul. 20, 2017

(54) NUTRITIONAL POWDER POD WITH EXTRUDED NUTRITIONAL POWDER

(71) Applicant: ABBOTT LABORATORIES, Abbott Park, IL (US)

(72) Inventors: CYNTHIA BLACK, Westerville, OH (US); YOUNGSUK HEO, Powell, OH (US); TIMOTHY LAPLANTE, Powell, OH (US); PETER WESTFALL, Westerville, OH (US); CATHERINE LAMB, Westerville, OH (US); MARK ENGLE, Plain City, OH (US); NAGENDRA RANGAVAJLA, Dublin, OH (US)

(73) Assignee: ABBOTT LABORATORIES, Abbott Park, IL (US)

(21) Appl. No.: 15/328,248

(22) PCT Filed: Jul. 21, 2015
(86) PCT No.: PCT/US2015/041292

§ 371 Date: Jan. 23, 2017

Related U.S. Application Data
(60) Provisional application No. 62/026,809, filed on Jul. 21, 2014.
(60) Provisional application No. 62/026,885, filed on Jul. 21, 2014.
(60) Provisional application No. 62/027,048, filed on Jul. 21, 2014.

(51) Int. Cl. B65D 85/804; A23P 10/40; A47J 31/40; A23L 33/00

(52) U.S. Cl. CPC B65D 85/8046; A23L 33/40; A23P 10/40; A47J 31/407; A23V 2002/00

(57) ABSTRACT

A nutritional powder pod for use in a beverage production machine is disclosed herein. The nutritional powder is prepared by an extrusion process. Also disclosed are processes for preparing a nutritional powder pod suitable for use in a beverage production machine. These processes include preparation of the nutritional powder by a process that includes extrusion.

### CROSS-REFERENCE TO RELATED APPLICATIONS

This application claims priority to and any benefit of U.S. Provisional Patent Application No. 62/026,809, filed Jul. 21, 2014; U.S. Provisional Patent Application No. 62/026,885, filed Jul. 21, 2014; and U.S. Provisional Patent Application No. 62/027,048, filed Jul. 21, 2014; the entire contents of which are incorporated by reference herein.

### FIELD

The present disclosure relates to a nutritional powder pod for use in a beverage production machine and to a process for preparing a nutritional powder pod. The process comprises preparation of a nutritional powder by extrusion and then packaging the nutritional powder in a pod to form a nutritional powder pod.

### BACKGROUND

Many consumers are familiar with beverage production machines that add water to a “pod” containing dry coffee or tea to produce a single serving of a hot beverage. These beverage production machines typically accept a container, also called a pod, designed for the particular model of machine, containing individual portions of a solid, concentrate, or other mixture intended to prepare the beverage of choice. The pods take various forms such as pouches, cartridges, cups, and so forth.

### SUMMARY

The present disclosure is directed to a nutritional powder pod for use in a beverage production machine. The present disclosure is also directed to a process for preparing a nutritional powder pod. The process comprises preparation of a nutritional powder by extrusion and then packaging the nutritional powder in a pod to form a nutritional powder pod (i.e., pod product).

In accordance with one exemplary embodiment, a process for preparing a nutritional powder pod for use in a beverage production machine is disclosed. The process comprises extruding a nutritional composition in an extruder, drying and milling the extruded nutritional composition to form a nutritional powder, and packaging the nutritional powder in a pod to form the nutritional powder pod.

In accordance with the preceding and other embodiments, a nutritional powder pod is also disclosed. The nutritional powder pod comprises an extruded nutritional powder and a pod enclosing the nutritional powder, wherein the pod is configured for use with a beverage production machine.

In accordance with the preceding and other embodiments, a package containing multiple nutritional powder pods is also disclosed. The nutritional powder pod comprises a nutritional powder and a pod enclosing the nutritional powder, wherein the pod is configured for use with a beverage production machine.

In accordance with the preceding and other embodiments, a process for preparing a liquid product, preferably an infant formula, is also disclosed. The process comprises using a nutritional powder pod with a beverage production machine capable of adding liquid to the nutritional powder, thereby producing the liquid nutritional product. The nutritional powder pod comprises a nutritional powder and a pod enclosing the nutritional powder.

### BRIEF DESCRIPTION OF THE DRAWINGS

Features and advantages of the general inventive concepts will become apparent from the following detailed description made with reference to the accompanying drawings.

FIG. 1: FIG. 1 is a scanning electron microscope (SEM) image showing the particle shape of an exemplary nutritional powder made using extrusion.

FIGS. 2-3: FIGS. 2 and 3 are graphs showing the reconstitution rate versus reconstitution time of the powders of Example 7 and the Comparative Example, respectively.

### DETAILED DESCRIPTION

A nutritional powder pod for use in a beverage production machine is described in detail herein. A process for preparing a nutritional powder pod is also described. The process comprises preparation of a nutritional powder by extrusion, and then packaging of the nutritional powder in a pod to form a nutritional powder pod. These and other features of the inventive concepts, as well as some of the many optional variations and additions, are described in detail hereafter.

### Definitions

The terms “adult formula” and “adult nutritional product” as used herein are used interchangeably to refer to nutritional compositions suitable for generally maintaining or improving the health of an adult.

The term “agglomerated” as used herein, unless otherwise specified, refers to a nutritional powder that is processed such that individual powder particles are fused together to form porous aggregates of powder particles. The agglomerated nutritional powders described herein may be produced according to well known processes including, but not limited to, rewetting agglomeration, fluid-bed agglomeration, pressure agglomeration, and instantization by spray lecithination.

The term “closed pores” as used herein, unless otherwise specified, refers to pores in a particle that are isolated from the surface of the particle.

The term “envelope powder volume” as used herein, unless otherwise specified, refers to the volume of particles in a given portion of a nutritional powder, including all open pores, closed pores, and interstitial void volume. Typically, the term “envelope powder volume” implies that the powder has been compressed or otherwise treated to reduce the amount of interstitial void volume in the powder, as compared to the interstitial void volume present in a similar loose bulk powder.

The term “infant,” as used herein, unless otherwise specified, refers to a human about 36 months of age or younger. The term “toddler,” as used herein, unless otherwise specified, refers to a subgroup of infants from about 12 months of age to about 36 months (3 years) of age. The term “child,” as used herein, unless otherwise specified, refers to a human about 3 years of age to about 18 years of age. The term “adult,” as used herein, unless otherwise specified, refers to a human about 18 years of age or older.

The terms “infant formula” or “infant nutritional product” as used herein are used interchangeably to refer to nutritional compositions that have the proper balance of macronutrients, micro-nutrients, and calories to provide sole or supplemental nourishment for and generally maintain or improve the health of infants, toddlers, or both. Infant formulas preferably comprise nutrients in accordance with the relevant infant formula guidelines for the targeted consumer or user population, an example of which would be the Infant Formula Act, 21 U.S.C. Section 350(a).

The term “initiation time” as used herein, unless otherwise specified, refers to the time at which any liquid from a beverage production machine first makes contact with or otherwise impinges upon the contents of a pod.

The term “interstitial void volume” as used herein, unless otherwise specified, refers to the open space between tightly-packed particles in a given portion of a nutritional powder.

The term “liquid product” as used herein, unless otherwise specified, refers to the reconstituted nutritional powder.

The term “majority” as used herein, unless otherwise specified, means more than 50%, including at least 60%, at least 65%, at least 70%, at least 75%, at least 80%, at least 85%, at least 90%, at least 95%, at least 99%, and up to and including 100%.

The term “nutritional composition” as used herein, unless otherwise specified, refers to nutritional products in various forms including, but not limited to, liquids, solids, powders, semi-solids, semi-liquids, nutritional supplements, and any other nutritional food product known in the art. As discussed below, a nutritional composition in powder form (i.e., a nutritional powder) may be reconstituted upon addition of water or another liquid to form a liquid product prior to administration to (e.g., providing to or consumption by) a subject. In certain embodiments disclosed herein, the nutritional compositions comprise at least one of a source of protein, a source of carbohydrate, and a source of fat. The nutritional compositions disclosed herein are generally suitable for oral consumption by a human.

The term “nutritional powder” as used herein, unless otherwise specified, refers to nutritional products that are solids or semisolids in the form of finely divided particles that are generally flowable or scoopable. A nutritional powder is usually reconstituted by the addition of water or another liquid to form a liquid nutritional composition (liquid product) prior to administration to (e.g., providing to or consumption by) an individual. As discussed below, in certain embodiments disclosed herein, the nutritional powders comprise at least one of a source of protein, a source of carbohydrate, and a source of fat.

The term “nutritional powder pod” refers to a pod containing a certain volume or mass of a nutritional powder. Unless otherwise indicated herein, the terms “nutritional powder pod” and “pod product” are interchangeable.

The term “open pores” as used herein, unless otherwise specified, refers to pores in a particle that have access to the surface of the particle.

The terms “particle” or “particles” as used herein, unless otherwise specified, refer to finely-divided pieces of solid material which make up a powder. It should be understood that “particles” includes both individual particles and agglomerated particles. When only individual particles are meant, the term “individual particle(s)” is used. When only agglomerated particles are meant, the term “agglomerated particle(s)” is used.

The terms “porosity” or “powder porosity” as used herein, unless otherwise specified, are interchangeable and refer to open porous space contained within and open space between the powder particles. Powder porosity includes both interstitial void volume and open pore volume within the particles.

The terms “pediatric formula” or “pediatric nutritional product,” as used herein, are used interchangeably to refer to nutritional compositions suitable for generally maintaining or improving the health of toddlers, children, or both.

The term “pod” as used herein, unless otherwise specified, refers to a sealable, re-sealable or sealed container having an internal volume capable of containing a solid, powder, or liquid formulation that, when mixed with liquid, yields a liquid product suitable for human consumption.

The terms “reconstitute,” “reconstituted,” and “reconstitution” as used herein, unless otherwise specified, are used interchangeably to refer to a process by which the nutritional powder is mixed with a liquid, such as water, to form an essentially homogeneous liquid product. Once reconstituted with the liquid, the ingredients of the nutritional powder may be any combination of dissolved, dispersed, suspended, colloidally suspended, emulsified, or otherwise blended within the matrix of the liquid product. Therefore, the resulting reconstituted liquid product may be characterized as any combination of a solution, a dispersion, a suspension, a colloidal suspension, an emulsion, or a homogeneous blend.

The term “serving” as used herein, unless otherwise specified, is any amount of a composition that is intended to be ingested by a subject in one sitting or within less than about one hour. The size of a serving (i.e., “serving size”) may be different for diverse individuals, depending on one or more factors including, but not limited to, age, body mass, gender, or health. For a typical human child or adult, a serving size of the compositions disclosed herein is from about 25 mL to about 1,000 mL. For a typical human infant or toddler, a serving size of the compositions disclosed herein is from about 5 mL to about 250 mL.

As discussed above, in accordance with one exemplary embodiment, a process for preparing a nutritional powder pod for use in a beverage production machine is disclosed. The process comprises extruding a nutritional composition in an extruder, drying and milling the extruded nutritional composition to form a nutritional powder, and packaging the nutritional powder in a pod to form the nutritional powder pod (i.e., packaging the nutritional powder in a pod to form a pod product).

As discussed above, in accordance with the preceding and other embodiments, a nutritional powder pod is also disclosed. The nutritional powder pod comprises an extruded nutritional powder and a pod enclosing the nutritional powder, wherein the pod is configured for use with a beverage production machine. In certain embodiments, the extruded nutritional powder can be recognized by its physical properties. More specifically, in certain embodiments, the extruded nutritional powder is a nutritional powder that comprises particles having at least one of a flake, spheroidal, cuboidal, plate, rod, and thread shape. In certain embodiments, the extruded nutritional powder is a nutritional powder that comprises a majority of particles having a non-spheroidal shape.

In accordance with the preceding and other embodiments, a package containing multiple nutritional powder pods is also disclosed. The nutritional powder pod comprises a nutritional powder and a pod enclosing the nutritional powder, wherein the pod is configured for use with a beverage production machine.

In accordance with the preceding and other embodiments, a process for preparing a liquid product, preferably an infant formula, is also disclosed. The process comprises using a nutritional powder pod with a beverage production machine capable of adding liquid to the nutritional powder, thereby producing the liquid nutritional product. The nutritional powder pod comprises a nutritional powder and a pod enclosing the nutritional powder.

### Process for Preparing a Nutritional Powder Pod

Disclosed herein is a process for preparing a nutritional powder pod. In accordance with the process described herein, an extruded nutritional composition is prepared using an extruder (also referred to herein as an “extrusion process”). In certain exemplary embodiments, the nutritional composition comprises at least one of a protein, a carbohydrate, and a fat. Some or all of the protein, carbohydrate, and fat, either individually or collectively, may be referred to throughout this application as the “nutritional ingredients.” In certain exemplary embodiments, the nutritional composition comprises a protein, a carbohydrate, and a fat, wherein at least a portion of the protein, at least a portion of the carbohydrate, at least a portion of the fat, and optional added moisture components are processed in the extruder to form an extruded nutritional composition. In certain embodiments, the product that exits the extruder is referred to as an extrudate; generally the extrudate will be paste-like in consistency and can contain varying amounts of moisture depending upon the amount and type of ingredients added to the extruder.

In certain exemplary embodiments of the extrusion process disclosed herein, some or all of the nutritional ingredients are introduced into one or more ports of the extruder as a dry blend or powder premix. The dry blend may be introduced into one or more ports of the extruder by a variety of techniques including, but not limited to, gravity feeding from a hopper, pumping from a storage tank, and the like.

In certain exemplary embodiments, additional moisture components are introduced into the extruder to hydrate the dry blend of nutritional ingredients that has been added. The amount of additional moisture components added to the nutritional composition during extrusion may be adjusted based on the desired physical properties of the extruded nutritional composition, and based on the particular nutritional ingredients added to the extruder (e.g., the amount of moisture, such as water, contained therein). In certain embodiments, the additional moisture components are liquid. In certain embodiments, the additional moisture component is water. In certain embodiments, the additional moisture component is steam. In other embodiments, the additional moisture components include water in combination with one or more water soluble components (e.g., water soluble vitamins and water soluble minerals). In certain embodiments, the additional moisture components are introduced into the extruder at one or more port of the extruder. The additional moisture components may be introduced into the extruder by a variety of methods such as by pumping the additional moisture components from a storage tank into the extruder. In certain embodiments, the additional moisture components are introduced into the extruder at a point upstream (e.g., an earlier port) of where the dry blend is introduced into the extruder. In other embodiments, the additional moisture components are introduced into the extruder at the same point (i.e., the same port of the extruder) where the dry blend is introduced into the extruder. In yet other embodiments, the additional moisture components are introduced into the extruder at a point downstream (e.g., at a later port) of where the dry blend is introduced into the extruder.

In those embodiments wherein the nutritional composition includes a source of fat, some or all of the fat may be introduced into the extruder as an oil or oil blend. The hydrated dry blend and the oil or oil blend are mixed to form an emulsified mixture within the extruder. The oil or oil blend may be introduced into the extruder by a variety of methods such as by pumping the oil or oil blend from a storage tank into the extruder. In certain embodiments, the oil or oil blend is introduced into the extruder downstream (e.g., at a later port) of where the dry blend and the additional moisture components are introduced into the extruder. In other words, the oil or oil blend is introduced into the extruder at a point at which the hydrated dry blend has already been formed. In certain embodiments, a portion of the oil or oil blend is introduced into the extruder at the same point (i.e., the same port of the extruder) where the additional moisture components are introduced into the extruder, and the remainder of the oil or oil blend is introduced into the extruder downstream (e.g., at a later port) of where the first dry blend and the additional moisture components are introduced into the extruder. In certain embodiments, the hydrated dry blend and the oil or oil blend are mixed together within the extruder to form an emulsified mixture. In certain embodiments, an additional liquid or slurry feed may be introduced into the extruder upstream or downstream (i.e., before or after) of where the oil or oil blend is introduced into the extruder.

Generally, any extruder known for use in food processing may be utilized in the process disclosed herein. The extruder may be used to produce the nutritional composition extrudate in batch format, or in a continuous process. In certain embodiments, extrusion is performed via a screw extruder. Suitable screw extruders include a twin screw extruder or a single screw extruder. Generally, twin screw extruders comprise a barrel having one or more ports for adding ingredients, two screws, and a die. The extruder screws are positioned inside of the barrel and may comprise shear elements, mixing elements, conveying elements, kneading elements, emulsifying elements, disc elements, or a combination of the above in any interchangeable order. The barrel of the extruder may comprise a number of segments that are bolted, clamped, or otherwise joined together. The barrel or barrel segments may be jacketed to permit indirect, controlled heating or cooling of the material being processed within the extruder. In addition, the barrel or barrel segments include one or more ports for adding ingredients into the extruder. The die comprises one or more openings which shape the extrudate as it flows out of the extruder. Certain extruders suitable for use in the process disclosed herein include, for example, extruders manufactured by Coperion GmbH.

In certain embodiments, the temperature of the material within the extruder may be controlled throughout the extruder. In certain embodiments, the barrels of the extruder may be heated by steam, hot oil, or electric. In certain exemplary embodiments, extrusion takes place at a temperature from about 30° C. to about 150° C., from about 40° C. to about 130° C., from about 60° C. to about 120° C., or from about 70° C. to about 100° C. In certain exemplary embodiments, the nutritional ingredients are processed in the extruder for about 10 seconds to about 240 seconds, including for about 30 seconds to about 180 seconds.

As discussed previously, after the nutritional composition is extruded, the resulting extruded nutritional composition is dried and milled to form a nutritional powder.

Generally, any conventional drying method or methods may be used to remove the desired amount of water from the extruded nutritional composition. For example, the extruded nutritional composition may be dried using a vacuum, microwave dryer, radio frequency drier, convective hot air, a tray dryer, infrared, drum dryer, or any combination of the above. In certain embodiments, the nutritional composition extrudate is dried at a temperature of from about 25° C. to about 225° C., including from about 25° C. to about 200° C., including from about 25° C. to about 170° C., including from about 50° C. to about 125° C., and including from about 70° C. to about 100° C. In certain embodiments, drying of the nutritional composition extrudate is carried out under vacuum, such as about 10 millibar (mbar) to about 100 mbar, or about 30 mbar. A combination of heat and vacuum may be utilized.

In certain embodiments, a vacuum belt dryer is used to dry the nutritional composition extrudate. The drying time will typically depend on the amount of liquid that was introduced into the extruder and that remains in the nutritional composition extrudate. In certain other embodiments, the nutritional composition extrudate may be dried using a continuous microwave dryer. In certain such embodiments, the nutritional composition extrudate may be pumped or otherwise transported through the microwave dryer via a conveyor passing through the microwave dryer. The nutritional composition extrudate may be deposited across the conveyor at a uniform density and a uniform thickness for optimum product characteristics. The desired thickness of the deposited extrudate may vary depending on the penetration depth of the microwave emitter. The microwave dryer may optionally use air flow in the interior of the microwave dryer to further aid in drying the nutritional composition extrudate. The air flow may be heated, dried, or both, prior to entering the microwave dryer, or the air may be ambient air as it exists near the process site.

In certain embodiments, the nutritional composition extrudate may be dried using a vacuum drum dryer. In certain embodiments, the drum dryer includes a pair of drums positioned substantially parallel with each other. In other embodiments, any other suitable number of drums may be used, and the following description should be considered to apply to those embodiments even though reference is made in the following sentences to two drums. The drums may be spaced apart to form a gap between the drums. The drums may rotate in opposing directions. The drums may be made of carbon or stainless steel and coated in a hard chrome-plated metal. The drums may be positioned within a housing. The nutritional composition extrudate may be distributed between the drums such that the extrudate adheres to the drums as the extrudate passes through the gap between the drums. The nutritional composition extrudate may be applied such that the extrudate is distributed substantially evenly onto the drums. In certain embodiments, the nutritional composition extrudate is gravity fed to the drums. Alternatively, a pump, a belt system, or any other suitable system may be used to feed the nutritional composition extrudate through the drums. The drums may be heated, such as with steam or thermal oil, to dry the nutritional composition extrudate applied to the drums. As the nutritional composition extrudate is applied to and rotates on the heated drums, the water in the nutritional composition extrudate evaporates. A scraper may be positioned adjacent to each drum such that the scrapers remove the dried nutritional composition extrudate adhered to the drum as the drum rotates against the scraper.

In certain embodiments, the dried form of the nutritional composition extrudate comprises no more than about 7 weight % water. For example, the nutritional composition extrudate may be dried to a water content of from about 0.5 weight % to about 7 weight %, including from about 0.5 weight % to about 5 weight %, including from about 0.75 weight % to about 5 weight %, including from about 1 weight % to about 4 weight %, including about 2 weight % to about 3 weight %, including about 2 weight % to about 2.5 weight %, and including about 2.5 weight % to about 3 weight %. It should be understood that prior to drying, the nutritional composition extrudate may have relatively more water, generally about 7 weight % to about 30 weight %, including about 10 weight % to about 20 weight %, including about 15 weight %.

Any conventional milling or grinding methods may be used to achieve a nutritional powder having one or more specified physical properties such as, for example, a desired particle size. In certain embodiments, because the nutritional powder has been made by a process that includes extrusion, it may be referred to as an extruded nutritional powder.

The general inventive concepts encompass optional process steps in addition to those disclosed above. For example, in certain embodiments, at least a portion of the protein, the carbohydrate, or the fat may be added to the extruded nutritional powder in the form of dry ingredients or a dry blend.

Following the drying and milling, the nutritional powder disclosed herein is packaged as a pod product, thereby forming a nutritional powder pod. The inventive concepts disclosed herein also encompass a package comprising multiple nutritional powder pods. The inventive concepts further encompass a kit comprising a beverage production machine and a nutritional powder pod according to any of the various embodiments described herein for use with the beverage production machine.

### Nutritional Powder Pods

As discussed above, the present disclosure relates to nutritional powder pods suitable for use in beverage production machines. The pod can be considered a container that encloses the nutritional powder. In certain embodiments, the pod includes one or more chambers therein and the nutritional powder is housed in at least one of the chambers. Generally, the pod may have a wide variety of shapes, sizes, and forms for housing the nutritional powder. For example, in certain exemplary embodiments, the pod may be formed as a cup, a cartridge, or a pouch. In certain embodiments, the pod is molded or otherwise constructed of a food-safe material, e.g., a plastic such as polypropylene or polyethylene, a metal or metal foil such as steel or aluminum, a natural product such as paper or other fiber based material, and combinations thereof. In certain embodiments, the pod is sealed, sealable, or re-sealable so as to protect the enclosed nutritional powder from external contamination and/or to retard degradation of the enclosed nutritional powder prior to use.

In certain embodiments, the pod contains an amount of extruded nutritional powder corresponding to a single serving (i.e., when reconstituted into a liquid product). The amount of nutritional powder corresponding to a single serving may vary, for example, based on the intended consumer (e.g., an infant, a toddler, a child, an adult, a healthy individual, a sick individual). In some instances, more nutritional powder than is needed for a single serving may be included in the pod, such as when an ingredient of the formulation is likely to degrade or otherwise lose effectiveness over time.

In certain embodiments, the pod encloses an amount of a nutritional powder that is suitable for being reconstituted into a single serving of a liquid product upon combination with a certain volume of liquid. In certain embodiments, the pods contain about 2 grams to about 150 grams of nutritional powder, including about 2 grams to about 100 grams, including about 2 grams to about 80 grams, including about 2 grams to about 60 grams, including about 2 grams to about 50 grams, including about 2 grams to about 35 grams, including about 2 grams to about 30 grams, including about 2 grams to about 25 grams, including about 2 grams to about 20 grams, including about 2 grams to about 15 grams, including about 2 grams to about 10 grams, including about 5 grams to about 150 grams, including about 5 grams to about 100 grams, including about 5 grams to about 80 grams, including about 5 grams to about 60 grams, including about 5 grams to about 50 grams, including about 5 to about 35 grams, including about 5 to about 30 grams, including about 5 to about 25 grams, including about 5 to about 20 grams, including about 5 grams to about 15 grams, including about 10 grams to about 150 grams, including about 10 grams to about 100 grams, including about 10 grams to about 80 grams, including about 10 grams to about 60 grams, including about 10 grams to about 50 grams, including about 10 grams to about 40 grams, including about 10 grams to about 35 grams, including about 10 grams to about 30 grams, including about 10 grams to about 25 grams, including about 10 grams to about 20 grams, including about 15 grams to about 150 grams, including about 15 grams to about 100 grams, including about 15 grams to about 80 grams, including about 15 grams to about 60 grams, including about 15 grams to about 50 grams, including about 15 grams to about 40 grams, including about 15 grams to about 35 grams, including about 15 grams to about 30 grams, including about 15 grams to about 25 grams, including about 20 grams to about 150 grams, including about 20 grams to about 100 grams, including about 20 grams to about 80 grams, including about 20 grams to about 60 grams, including about 20 grams to about 50 grams, including about 20 grams to about 40 grams, including about 20 grams to about 35 grams, including about 20 grams to about 30 grams, including about 25 grams to about 150 grams, including about 25 grams to about 100 grams, including about 25 grams to about 80 grams, including about 25 grams to about 60 grams, including about 25 grams to about 50 grams, including about 25 grams to about 40 grams, including about 25 grams to about 35 grams, including about 30 grams to about 150 grams, including about 30 grams to about 100 grams, including about 30 grams to about 80 grams, including about 30 grams to about 60 grams, including about 30 grams to about 50 grams, including about 30 grams to about 40 grams, including about 40 grams to about 150 grams, including about 40 grams to about 100 grams, including about 40 grams to 80 grams, including about 40 to 60 grams, including about 40 to 50 grams, including about 50 grams to about 150 grams, and including about 50 to 100 grams of nutritional powder. In certain embodiments, the pods contain about 8 grams, about 10 grams, about 12 grams, about 15 grams, about 20 grams, about 25 grams, about 30 grams, about 35 grams, about 40 grams, about 50 grams, about 60 grams, about 80 grams, about 90 grams, about 100 grams, about 125 grams, or about 150 grams of nutritional powder.

In certain embodiments, the nutritional powder may be contained in the pod such that a headspace in the pod includes a maximum of about 10% O₂ (i.e. less than or equal to about 10% O₂), thereby reducing oxidation of the nutritional powder or formula and preventing the development of undesirable flavors, smells, and textures.

In certain embodiments, the nutritional powder is in the form of a flowable or substantially flowable powder. In certain embodiments, the nutritional powder is in the form of a powder that can be easily scooped and measured with a spoon or similar other device, such that the nutritional powder can be accurately measured for reconstitution with a suitable liquid, typically water, to form a liquid product for immediate consumption. In this context, “immediate” consumption generally means within about 48 hours, more typically within about 24 hours, in some embodiments within about 1 hour, and in some embodiments, immediately after reconstitution.

In certain embodiments, the contents of the pod (i.e., the nutritional powder) is intended to be processed (i.e., reconstituted into a liquid product suitable for oral consumption by an individual) within seconds after the hermetic seal of the pod is broken to allow liquid to flow therein, the contents to flow therefrom, or a combination thereof. In such embodiments, the pod will typically be a single-use, disposable container. In other embodiments, the pod is sealable or re-sealable and is capable of re-use. In certain embodiments where the pod is sealable or re-sealable, the contents of the pod (i.e., the nutritional powder) may be stored for a short time (typically hours, days, or a week or more) by the consumer prior to reconstituting into a liquid product and the pod may or may not be hermetically sealed at any point.

In certain embodiments, any delay between the time the hermetic seal of the pod is disrupted and the initiation time (as defined above) is less than 1 second. In other embodiments, any delay between the time the hermetic seal of the pod is disrupted and the initiation time is less than 2 seconds. In other embodiments, any delay between the time the hermetic seal of the pod is disrupted and the initiation time is less than 3 seconds. In other embodiments, any delay between the time the hermetic seal of the pod is disrupted and the initiation time is less than 4 seconds. In other embodiments, any delay between the time the hermetic seal of the pod is disrupted and the initiation time is less than 5 seconds. In other embodiments, any delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

### Nutritional Powder Reconstitution

In certain embodiments, the inventive concepts encompass a process comprising using the nutritional powder pod disclosed herein with a beverage production machine capable of adding liquid to the nutritional powder to reconstitute the nutritional powder into a liquid product.

In some embodiments, the pod may be configured to receive an injector or similar device through which water, air, liquids, or other fluids (steam) may be introduced to facilitate mixing and reconstitution within the enclosed volume. In some embodiments, the liquid introduced to the pod may be pre-filtered or alternatively may pass through a filtration unit disposed within the pod. In some embodiments, an outlet member integrally formed as part of or movably coupled to the pod may be positioned for dispensing from the pod.

In order to ensure adequate delivery of the ingredients in the nutritional powder, the nutritional powder is reconstituted with a defined amount of liquid. In certain embodiments, the liquid is passed into and through the nutritional powder pod, mixing with the nutritional powder to reconstitute it into a liquid product, which is collected in a glass (e.g., a cup), bottle (e.g., an infant formula bottle), or similar container. The reconstitution may take place inside the pod, inside the glass, bottle, or similar container into which the product is collected, or both inside the pod and inside such glass, bottle, or similar container. In certain embodiments, the liquid is passed into the nutritional powder pod, mixing with the nutritional powder to reconstitute it into a liquid product inside the pod, which may be further dispensed from the pod and collected in a glass, bottle, or similar container. In certain embodiments, the liquid is injected into and passed through the nutritional powder pod, mixing with the nutritional powder to reconstitute it into a liquid product, which is collected in a glass, bottle, or similar container. The reconstitution may take place inside the pod, inside the glass, bottle, or similar container into which the product is collected, or both inside the pod and inside such glass, bottle, or similar container. In certain embodiments, the liquid is injected into the nutritional powder pod, mixing with the nutritional product to reconstitute it into a liquid product inside the pod, which may be further dispensed from the pod and collected in a glass, bottle, or similar container.

In some exemplary embodiments, the volume of the liquid dispensed from the beverage production machine may range from about 5 mL to about 1,000 mL, including from about 25 mL to about 1,000 mL, further including from about 5 mL to about 250 mL.

In some exemplary embodiments, the nutritional powders are reconstituted into a liquid product within a range of about 10 seconds to about 5 minutes from the initiation time. In certain embodiments, the nutritional powder contained in the pod has a rate of reconstitution (defined below) of from about 0.02 mg/g-sec to about 20 mg/g-sec, including from about 0.03 mg/g-sec to about 18 mg/g-sec, including from about 0.04 mg/g-sec to about 17 mg/g-sec, including from about 0.05 mg/g-sec to about 16 mg/g-sec, including from about 0.05 mg/g-sec to about 8 mg/g-sec, including from about 0.5 mg/g-sec to about 8 mg/g-sec, including from about 0.3 mg/g-sec to about 8 mg/g-sec, including from about 0.2 mg/g-sec to about 16 mg/g-sec, including from about 1.2 mg/g-sec to about 16 mg/g-sec, including from about 3.1 mg/g-sec to about 16 mg/g-sec, including from about 0.1 mg/g-sec to about 12 mg/g-sec, including from about 0.9 mg/g-sec to about 12 mg/g-sec, including from about 1.4 mg/g-sec to about 12 mg/g-sec, including from about 0.1 mg/g-sec to about 10 mg/g-sec, including from about 0.1 mg/g-sec to about 8 mg/g-sec, including from about 0.2 mg/g-sec to about 6 mg/g-sec, including from about 0.3 mg/g-sec to about 5 mg/g-sec, including from about 0.5 mg/g-sec to about 2.5 mg/g-sec, including from about 0.8 mg/g-sec to about 1.5 mg/g-sec, including from about 1 mg/g-sec to about 10 mg/g-sec, including from about 1.5 mg/g-sec to about 10 mg/g-sec, including from about 2 mg/g-sec to about 8 mg/g-sec, including from about 2.5 mg/g-sec to about 7.5 mg/g-sec, and including from about 3 mg/g-sec to about 6 mg/g-sec. Without being bound by theory, it is believed that as a result of being within the specified rate of reconstitution, the nutritional powder contained within the nutritional powder pod exhibits generally good reconstitution (e.g., minimal clumping of the nutritional powder) when the nutritional powder pod is used in a beverage production machine.

Generally a beverage production machine places certain limitations on the conditions under which reconstitution takes place. For example, the beverage production machine may inject a specified volume of liquid at a specified temperature into the nutritional powder pod. In certain exemplary embodiments, liquid is mixed with the nutritional powder from the pod at a temperature between about 5° C. and about 50° C., including about 5° C. to about 40° C., including about 5° C. to about 30° C., including about 5° C. to about 20° C., including about 5° C. to about 10° C., including about 10° C. to about 50° C., including about 20° C. to about 50° C., including about 30° C. to about 50° C., and including about 40° C. to about 50° C. In certain of the same or other exemplary embodiments, the liquid is mixed with the nutritional powder at a pressure ranging from 0.5 bar to 15 bar, including about 0.5 to about 13 bar, including about 0.5 to about 10 bar, including about 0.5 bar to about 5 bar, and including about 1 bar to about 5 bar.

When preparing a liquid product from a nutritional powder, it is desirable that the nutritional powder be accurately and fully incorporated into the beverage. However, not all nutritional powders may be optimal for use in a beverage production machine. Nutritional powders can be manufactured by a variety of processes, including, for example, a spray-drying process or an extrusion process. The manufacturing process may affect various characteristics of the nutritional powders such as the particle size, shape, and surface area, which in turn may affect the ability of the nutritional powder to rapidly reconstitute in water via a beverage production machine.

It can be undesirable, for instance, for there to be a residue of dry nutritional powder left at the bottom of a container or for the nutritional powder to form clumps that fail to reconstitute in the liquid product. This is particularly important with infant formulas, because these formulas typically provide the sole source or a supplemental source of nourishment to the infant. Generally, an infant formula powder must be fully reconstituted, so the infant receives a full serving of nutrients and calories provided by the formula. Additionally, any unreconstituted nutritional powder left within the nutritional powder pod is typically discarded, which is wasteful both economically and environmentally. Any unreconstituted powder within a beverage production machine may create clumps that can deposit within or clog the inner workings of the machine, which can cause machine failure or create sites for microbial growth and contamination.

For these reasons, in certain embodiments, the nutritional powder in the nutritional powder pod is essentially reconstituted into the liquid product by the beverage preparation machine. In certain embodiments, essentially reconstituted means that at least 75% of the mass of the nutritional powder is reconstituted into the liquid product, including at least 80%, at least 90%, at least 95%, at least 98%, at least 98.5%, at least 98.7%, at least 98.9%, at least 99%, at least 99.3%, at least 99.5% and 75-100%, 75-95%, 75-90%, 75-80%, 80-100%, 80-95%, 80-90%, 90-100%, 90-95%, 95-100%, 96-100%, 97-100%, 98-100%, 98.5-100%, 98.7-100%, 99-100%, 99.3-100%, and 99.5-100% of the mass of the nutritional powder.

In some exemplary embodiments, the liquid product may comprise a Hunter Lab “L” value between about 20 and about 100, including between about 35 and about 100, between about 50 and about 100, and between about 75 and about 100. The Hunter Lab “L” value is a measurement of the lightness of the liquid product. The Hunter Lab “L” value of the nutritional formula can be measured by a spectrophotometer, which allows quantitative measurement of the reflection or transmission properties of the liquid product as a function of wavelength.

The liquid product may comprise a Hunter Lab “a” value between about −5.00 and about 1.00, including between about 0 and about 1.00, between about −5.00 and about 0, between about −4.00 and −1.00, and between about −3.00 and about −2.00. The Hunter Lab “a” value is a measurement of the color-opponent dimension of a liquid product. The Hunter Lab “a” value of the nutritional product can be measured by a spectrophotometer, which allows quantitative measurement of the reflection or transmission properties of the liquid product as a function of wavelength.

The liquid product may comprise a Hunter Lab “b” value between about 1 and about 30, including between about 1 and about 25, further including between about 26 and about 30. The Hunter Lab “b” value is a measurement of the color-opponent dimension of a liquid product. The Hunter Lab “b” value of the nutritional formula can be measured by a spectrophotometer, which allows quantitative measurement of the reflection or transmission properties of the liquid product as a function of wavelength.

### Physical Properties of Nutritional Powders

As discussed in more detail herein, in certain embodiments, the nutritional powders of the nutritional powder pods may be characterized by certain physical properties.

In certain exemplary embodiments, the nutritional powder within the nutritional powder pod has a water activity level of about 0.1 to about 0.5, including about 0.1 to about 0.45, including about 0.1 to about 0.30, including about 0.1 to about 0.25, including about 0.1 to about 0.24, including about 0.15 to about 0.50, including about 0.15 to about 0.45, including about 0.15 to about 0.30, including about 0.15 to about 0.25, including about 0.15 to about 0.24, including about 0.19 to about 0.50, including about 0.19 to about 0.45, including about 0.19 to about 0.30, including about 0.19 to about 0.25, and including about 0.19 to about 0.24. In certain exemplary embodiments, the nutritional powder within the nutritional powder pod has a water activity level of about 0.25 to about 0.45. Water activity measures the ratio of the equilibrium vapor pressure of the powder compared to the equilibrium vapor pressure of pure water at a particular temperature. For purposes of the water activity numbers provided herein, that temperature can be considered to be room temperature (i.e., 25° C.).

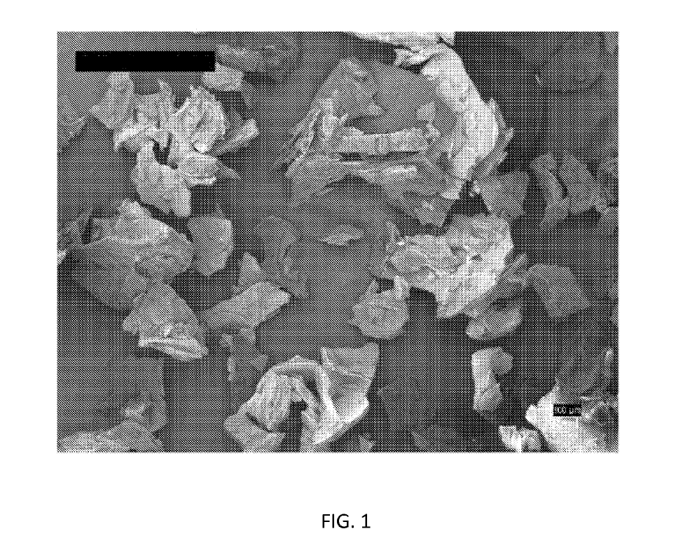

Particle morphology (i.e., structure and/or shape) can also be an important parameter for analyzing nutritional powder behavior upon reconstitution to a liquid product. Relatively spheroidal or globular individual particles are easy to describe because of their symmetry. As used herein, the term spheroidal is intended to encompass spheres and sphere-like shapes (i.e., non-perfect spheres such as ellipses). On the other hand, as those of skill in the art will understand, the description of non-spherical particles may be challenging due to the potential asymmetry or irregularity of shape. In certain embodiments, a majority of the nutritional powder particles produced by the extrusion process described herein have a non-spheroidal shape, e.g., are flakes, plates, rods, threads or cuboidal. In certain embodiments, the size and shape of the nutritional powder particles produced by the extrusion process described herein may be characterized by a variety of parameters such as, for example, aspect ratio, circularity, convexity, circular equivalent diameter, elongation, high sensitivity (HS) circularity, solidity fiber elongation, fiber straightness, or the like. A non-limiting and exemplary example of particles of a nutritional powder having non-spheroidal shapes that can be described as flakes, plates, rods, threads, or a combination thereof and produced by the extrusion process disclosed herein is provided in FIG. 1. A number of methods have been used to describe non-spherical particles.

The morphology of the particles of the nutritional powder, such as aspect ratio, circular equivalent diameter, and circularity, may be analyzed according to various known processes, including, but not limited to, by use of a Malvern Morphologi G3 particle characterization system, which measures the size and shape of particles via static image analysis. This exemplary instrument captures images of individual particles by scanning the sample underneath the microscope optics, while keeping the particles in focus.

One common measurement to describe and quantify non-spherical particles, particularly particles of elongated shape (e.g., rods), is the aspect ratio, which is the shortest dimension of the particle divided by the longest dimension. In certain embodiments, the nutritional powder comprises particles having an aspect ratio from about 0.1 to about 1, including from about 0.1 to about 0.9, including from about 0.2 to about 0.9, including from about 0.3 to about 0.9, including from about 0.4 to about 0.9, including from about 0.5 to about 0.9, including from about 0.6 to about 0.9, including from about 0.7 to about 0.9, including from about 0.1 to about 0.8, including from about 0.2 to about 0.8, including from about 0.3 to about 0.8, including from about 0.4 to about 0.8, including from about 0.5 to about 0.8, including from about 0.6 to about 0.8, including from about 0.7 to about 0.8, including from about 0.72 to about 0.8, and including from about 0.72 to about 0.79. Unless otherwise indicated, the aspect ratios disclosed herein are determined using a Malvern Morphologi G3 particle characterization system.

Another measurement used to characterize the morphology of the particles of the nutritional powder disclosed herein is circular equivalent diameter, which is the diameter of a circle of equivalent area as determined from the particle. The equivalent area refers to the projected area, or in other words, the two-dimensional area of a three-dimensional object obtained by projecting its shape onto an arbitrary plane. In certain embodiments, the nutritional powder comprises particles having a circular equivalent diameter of from about 0.5 μm to about 1000 μm, including from about 2 μm to about 700 μm, including from about 62 μm to about 553 μm, including from about 85 μm to about 470 μm, including from about 210 μm to about 400 μm, including from about 250 μm to about 310 μm, and including from about 350 μm to about 400 μm. Unless otherwise indicated, the circular equivalent diameter measures disclosed herein are determined using a Malvern Morphologi G3 particle characterization system.

Another measurement used to characterize the morphology of the particles of the nutritional powder disclosed herein is circularity, which is the circumference of a circle of equivalent area divided by the actual perimeter of the particle. In certain embodiments, the nutritional powder comprises particles having circularity from about 0.5 to about 1, including from about 0.65 to about 1, including from about 0.84 to about 0.97, including from about 0.86 to about 0.97, including from about 0.87 to about 0.96, including from about 0.89 to about 0.97, including from about 0.90 to about 0.96, including from about 0.92 to about 0.96, and including from about 0.94 to about 0.96. Unless otherwise indicated, the circularity measures disclosed herein are determined using a Malvern Morphologi G3 particle characterization system.

In certain exemplary embodiments, the size of the particles of the nutritional powder may additionally or otherwise be evaluated via a laser diffraction particle size analyzer, such as, for example, a Sympatec HELOS Model 1005 laser diffraction sensor including a laser operating at 632.8 nm. In certain exemplary embodiments, the nutritional powder comprises particles having particle size distribution where at least about 80% by number of the particles are from about 0.1 μm to about 1000 μm (based on the D10, D50, and D90 particle size values). In certain embodiments, the nutritional powder has a particle size distribution where at least about 80% by number of the particles are from about 10 μm to about 1000 μm, including from about 10 μm to about 750 μm, including from about 10 μm to about 500 μm, including from about 25 μm to about 1000 μm, including from about 25 μm to about 780 μm, including from about 25 μm to about 750 μm, including from about 25 μm to about 500 μm, including from about 30 μm to about 1000 μm, including from about 30 μm to about 777 μm, including from about 30 μm to about 750 μm, including from about 30 μm to about 500 μm, including from about 45 μm to about 490 μm, including from about 46 μm to about 482 μm, including from about 50 μm to about 1000 μm, from about 50 μm to about 750 μm, including from about 50 μm to about 500 μm, including from about 75 μm to about 1000 μm, including from about 75 μm to about 750 μm, including from about 75 μm to about 500 μm, including from about 100 μm to about 1000 μm, including from about 100 μm to about 750 μm, and including from about 100 μm to about 500 μm.

In certain exemplary embodiments, the nutritional powder comprises particles having a mean particle size from about 25 μm to about 1000 μm, including from about 80 μm to about 200 μm, and including from about 100 μm to about 190 μm, including from about 125 μm to about 450 μm, including from about 150 μm to about 400 μm, including from about 160 μm to about 380 μm, including from about 164 μm to about 379 μm, including from about 175 μm to about 350 μm, including from about 200 μm to about 300 μm, and including from about 225 μm to about 250 μm. As used herein, “mean particle size” refers to the average diameter of all the particles in a powder sample, determined based on the particle size distribution as measured by the laser diffraction particle size analyzer.

In certain exemplary embodiments, the nutritional powder comprises particles having a surface area of from about 0.02 m²/g to about 3 m²/g, including from about 0.02 m²/g to about 2 m²/g, including from about 0.02 m²/g to about 0.3 m²/g, including from about 0.02 m²/g to about 0.15 m²/g, including from about 0.03 m²/g to about 0.12 m²/g, including from about 0.04 m²/g to about 0.1 m²/g, including from about 0.05 m²/g to about 0.09 m²/g, and including from about 0.06 m²/g to about 0.08 m²/g. In certain embodiments, the surface area of the particles may be measured according to a Brunauer-Emmett-Teller (BET) multilayer gas adsorption method. In accordance with such methods, “adsorption” is the accumulation of atoms or molecules on the surface of a material. This adsorption is usually described through isotherms, as in, the amount of adsorbate on the adsorbent as a function of its pressure at constant temperature. This accumulation process creates a film of the adsorbate (the molecules or atoms being accumulated) on the surface of the adsorbent. Thus, the BET theory aims to explain the physical adsorption of gas molecules on a solid surface, and serves as the basis for an analysis technique or the measurement of the surface area of a material. Exemplary BET methods include, but are not limited, to those similar to or according to ISO-9277 (Determination of the specific surface area of solid by gas adsorption-BET method).

Wettability is another characteristic that can affect the reconstitution of a nutritional powder into a liquid product. As such, the wettability of the nutritional powder can affect the overall flow performance of the liquid product through the beverage production machine. Generally, wettability is a measure of the ability of a nutritional powder to absorb water on the surface, to be wetted, and to penetrate the surface of still water. The wettability of the nutritional powder may be measured indirectly by adding the nutritional powder to the surface of water in a container (e.g., a beaker) and recording the time it takes for the nutritional powder to fall below the surface. In certain exemplary embodiments, the nutritional powder contained in the nutritional powder pod of the present disclosure may have a wettability of about 1 second to about 200 seconds, including about 1 second to about 150 seconds, including about 5 seconds to about 125 seconds, including about 6 seconds to about 120 seconds, including about 10 seconds to about 145 seconds, including about 30 seconds to about 140 seconds, including about 60 seconds to about 130 seconds, including about 90 seconds to about 125 seconds, and including about 115 seconds to about 125 seconds.

Another characteristic that can affect the reconstitution of a nutritional powder is dispersibility. In general, dispersibility refers to the ease with which clumps and/or agglomerates of the nutritional powder particles fall apart (i.e., spread or disperse) in a liquid, such as water. The dispersibility of a nutritional powder may be evaluated by a variety of methods. One particular method includes the following steps: pouring a container of the reconstituted nutritional powder through an 8 inch 80 mesh sieve; adding 100 mL of slightly warm water (e.g., about 80° F. to about 95° F.) to the container and gently swirling to remove any additional clumps or residue; pouring the rinse through the 80 mesh sieve, distributing the pour around as much area of the sieve as possible; and counting the total number of particles sieved and measuring the size of each particle, clump, or agglomeration that does not pass through the 80 mesh sieve using a millimeter measuring stick. In general, the lower the number of undissolved particles reflects a better dispersibility. For example, a nutritional powder exhibiting good dispersibility will have a minimal number (e.g., less than about 100) of undissolved particles when reconstituted. In certain exemplary embodiments, nutritional powders disclosed herein has a dispersability of 0-5 undispersed particles greater than or equal to 5 mm, including 0 undispersed particles greater than or equal to 5 mm. In certain exemplary embodiments, nutritional powders disclosed herein has a dispersability of 0-10 undispersed particles at 2-4 mm, including 0-3 undispersed particles at 2-4 mm, and including 0 undispersed particles at 2-4 mm. In certain exemplary embodiments, nutritional powders disclosed herein has a dispersability of 0-30 undispersed particles at less than or equal to 1 mm, including 0-20 undispersed particles at less than or equal to 1 mm, and including 0-15 undispersed particles at less than or equal to 1 mm, including 0-13 undispersed particles at less than or equal to 1 mm, including 0-10 undispersed particles at less than or equal to 1 mm, including 0-5 undispersed particles at less than or equal to 1 mm, and including 0-4 undispersed particles at less than or equal to 1 mm.

An additional characteristic that may affect the reconstitution of the nutritional powder of nutritional powder pod as disclosed herein is powder porosity. The powder porosity may be measured by mercury porosimetry, as discussed in greater detail below. In certain exemplary embodiments, the nutritional powder of the nutritional powder pod has a powder porosity of from about 5% to about 80%. In certain embodiments, the nutritional powder has a powder porosity of from about 10% to about 80%, including from about 20% to about 80%, including from about 25% to about 78%, including from about 30% to about 76%, including from about 35% to about 75%, including from about 37% to about 67%, including from about 40% to about 75%, including from about 45% to about 75%, including from about 50% to about 72%, including from about 50% to about 70%, and including from about 60% to about 67%. In certain embodiments, the nutritional powder has a powder porosity of about 5%, about 10%, about 15%, about 20%, about 25%, about 30%, about 35%, about 37%, about 40%, about 45%, about 50%, about 52%, about 55%, about 60%, about 65%, about 67%, about 70%, about 75%, and about 80%.

In certain embodiments, in order to increase or enhance the powder porosity of the nutritional powder, a pressurized gas may be introduced into the nutritional emulsion at a suitable time during the manufacturing process. This pressurized gas may dissolve into the nutritional emulsion during the blending stages if these stages are similarly conducted under pressure. During the extrusion (or any spray drying) stages that are used in the preparation of the powder product, though, the pressure may be reduced, allowing the depressurized gas to bubble out of the particles of nutritional powder that are being formed at this stage. The exiting gas bubbles may leave a greater number of open pores or expanded open pores in the nutritional powder particles.

### Nutritional Compositions and Nutritional Powders

As previously discussed, the nutritional powders and liquid products that are reconstituted therefrom may be utilized for various purposes. Specific non-limiting examples of reconstituted food or beverage forms for the nutritional powders include infant formulas, toddler formulas, pediatric formulas, adult formulas, human milk fortifiers, preterm infant formulas, elemental and semi-elemental formulas, and nutritional supplements. In certain embodiments, when the nutritional powder is an infant formula, the nutritional powder pod, the packaging for the nutritional powder pods, or both are labeled with information indicating that the formula within is an infant formula and is intended for consumption by infants. In certain embodiments, when the nutritional powder is a pediatric formula, the nutritional powder pod, the packaging for the nutritional powder pods, or both are labeled with information indicating that the formula within is a pediatric formula and is intended for consumption by toddlers, children, or both. In certain embodiments, when the nutritional powder is an adult nutritional formula, the nutritional powder pod, the packaging for the nutritional powder pods, or both are labeled with information indicating that the formula within is an adult nutritional formula and is intended for consumption by adults. In certain embodiments, when the nutritional powder is an adult formula, the nutritional powder includes one or more flavorings, examples of which include, but are not limited to vanilla, chocolate, fruit flavors, vegetable flavors, coffee, and butter pecan.

In certain embodiments, the nutritional powder may be formulated with sufficient kinds and amounts of nutrients so as to provide a sole, primary, or supplemental source of nutrition for the individual for whom the liquid product is intended (i.e., an infant, a toddler, a child or an adult).

Generally, nutritional powders have a caloric density tailored to the nutritional needs of the ultimate user. In typical instances, nutritional powders may comprise from about 65 to about 800 kcal/100 g, including from about 90 to about 550 kcal/100 g, and also including from about 150 to about 550 kcal/100 g. Other caloric densities are within the scope of the present disclosure.

### Macronutrients

As discussed above, in certain embodiments, the nutritional composition, the nutritional powder, or both comprises one or more macronutrients selected from the group of protein, carbohydrate, fat, and mixtures thereof. In certain embodiments, the nutritional composition, the nutritional powder, or both comprise at least one source of protein, at least one source of carbohydrate, and at least one source of fat. Generally, any source of protein, carbohydrate, or fat that is suitable for use in nutritional products is also suitable for use herein, provided that such macronutrients are also compatible with the essential elements of the nutritional powders as defined herein.

Although total concentration or amounts of protein, carbohydrates, and fat may vary depending upon the nutritional needs of the particular individual for whom the nutritional powder is formulated, such concentrations or amounts most typically fall within one of the following embodied ranges, inclusive of any other essential protein, carbohydrate, or fat ingredients as described herein.

In certain embodiments, when the nutritional powder is formulated as an infant formula, the protein component is typically present in an amount of from about 5% to about 35% by weight of the infant formula (i.e., the powder infant formula), including from about 10% to about 30%, from about 10% to about 25%, from about 15% to about 25%, from about 20% to about 30%, from about 15% to about 20%, and also including from about 10% to about 16% by weight of the infant formula (i.e., the powder infant formula). The carbohydrate component is typically present in an amount of from about 40% to about 75% by weight of the infant formula (i.e., the powder infant formula), including from about 45% to about 75%, from about 45% to about 70%, from about 50% to about 70%, from about 50% to about 65%, from about 50% to about 60%, from about 60% to about 75%, from about 55% to about 65%, and also including from about 65% to about 70% by weight of the infant formula (i.e., the powder infant formula). The fat component is typically present in an amount of from about 10% to about 40% by weight of the infant formula, including from about 15% to about 40%, from about 20% to about 35%, from about 20% to about 30%, from about 25% to about 35%, and also including from about 25% to about 30% by weight of the infant formula (i.e., the powder infant formula).

In certain embodiments, when the nutritional powder is formulated as a pediatric formula, the protein component is typically present in an amount of from about 5% to about 30% by weight of the pediatric formula (i.e., the powder pediatric formula), including from about 10% to about 25%, from about 10% to about 20%, from about 10% to about 15%, from about 15% to about 20%, and also including from about 12% to about 20% by weight of the pediatric formula (i.e., the powder pediatric formula). The carbohydrate component is typically present in an amount of from about 40% to about 75% by weight of the pediatric formula (i.e., the powder pediatric formula), including from about 45% to about 70%, from about 50% to about 70%, from about 55% to about 70%, and also including from about 55% to about 65% by weight of the pediatric formula (i.e., the powder pediatric formula). The fat component is typically present in an amount of from about 10% to about 25% by weight of the pediatric formula (i.e., the powder pediatric formula), including from about 12% to about 20%, and also including from about 15% to about 20% by weight of the pediatric formula (i.e., the powder pediatric formula).

Additional suitable ranges for proteins, carbohydrates, and fats in those embodiments where the nutritional powder is formulated as an infant formula or a pediatric formula, based on the percentage of total calories of the nutritional powder, are set forth in Table 1.

TABLE 1

| | Embodiment A | Embodiment B | Embodiment C |
|---|---|---|---|
| Macronutrient | (% Calories) | (% Calories) | (% Calories) |
| Protein | 2-75 | 5-50 | 7-40 |
| Carbohydrate | 1-85 | 30-75 | 35-65 |
| Fat | 5-70 | 20-60 | 25-50 |

Note:
Each numerical value in the table is preceded by the term “about.”

In certain embodiments, when the nutritional powder is formulated as an adult nutritional product, the protein component is typically present in an amount of from about 5% to about 35% by weight of the adult nutritional product (i.e., the powder adult formula), including from about 10% to about 30%, from about 10% to about 20%, from about 15% to about 20%, and including from about 20% to about 30% by weight of the adult nutritional product (i.e., the powder adult formula). The carbohydrate component is typically present in an amount of from about 40% to about 80% by weight of the adult nutritional product (i.e., the powder adult formula), including from about 50% to about 75%, from about 50% to about 65%, from about 55% to about 70%, and also including from 60% to 75% by weight of the adult nutritional product (i.e., the powder adult formula). The fat component is typically present in an amount of from about 0.5% to about 20%, including from about 1% to about 15%, from about 1% to about 10%, from about 1% to about 5%, from about 5% to about 20%, from about 10% to about 20%, and also including from about 15% to about 20% by weight of the adult nutritional product (i.e., the powder adult formula).

Additional suitable ranges for proteins, carbohydrates, and fats in those embodiments where the nutritional powder is formulated as an adult nutritional product, based on the percentage of total calories of the nutritional powder, are set forth in Table 2.

TABLE 2

| | Embodiment D | Embodiment E | Embodiment F |
|---|---|---|---|
| Macronutrient | (% Calories) | (% Calories) | (% Calories) |
| Protein | 1-98 | 5-80 | 15-55 |
| Carbohydrate | 1-98 | 0-75 | 20-50 |
| Fat | 1-98 | 20-70 | 25-40 |

Note:
Each numerical value in the table is preceded by the term “about.”

In certain embodiments, the nutritional composition, the nutritional powder, or both includes protein or a source of protein. Generally, any source of protein may be used so long as it is suitable for oral nutritional compositions and is otherwise compatible with any other selected ingredients or features in the nutritional composition. Non-limiting examples of suitable proteins (and sources thereof) suitable for use in the nutritional powders described herein include, but are not limited to, intact, hydrolyzed, or partially hydrolyzed protein, which may be derived from any known or otherwise suitable source such as milk (e.g., casein, whey), animal (e.g., meat, fish), cereal (e.g., rice, corn, wheat), vegetable (e.g., soy, pea, potato, bean), and combinations thereof. The protein may also include a mixture of amino acids (often described as free amino acids) known for use in nutritional products or a combination of such amino acids with the intact, hydrolyzed, or partially hydrolyzed proteins described herein. The amino acids may be naturally occurring or synthetic amino acids.

More particular examples of suitable protein (or sources thereof) used in the nutritional composition, the nutritional powder, or both disclosed herein include, but are not limited to, whole cow's milk, partially or completely defatted milk, milk protein concentrates, milk protein isolates, nonfat dry milk, condensed skim milk, whey protein concentrates, whey protein isolates, acid caseins, sodium caseinates, calcium caseinates, potassium caseinates, legume protein, soy protein concentrates, soy protein isolates, pea protein concentrates, pea protein isolates, collagen proteins, potato proteins, rice proteins, wheat proteins, canola proteins, quinoa, insect proteins, earthworm proteins, fungal (e.g., mushroom) proteins, hydrolyzed yeast, gelatin, bovine colostrum, human colostrum, glycomacropeptides, mycoproteins, proteins expressed by microorganisms (e.g., bacteria and algae), and combinations thereof. The nutritional powders described herein may include any individual source of protein or combination of the various sources of protein listed above.

In addition, the proteins for use herein can also include, or be entirely or partially replaced by, free amino acids known for use in nutritional products, non-limiting examples of which include L-tryptophan, L-glutamine, L-tyrosine, L-methionine, L-cysteine, taurine, L-arginine, L-carnitine, and combinations thereof.

In certain embodiments, the nutritional composition, the nutritional powder, or both described herein include a protein component that consists of only intact or partially hydrolyzed protein; that is, the protein component is substantially free of any protein that has a degree of hydrolysis of 25% or more. In this context, the term “partially hydrolyzed protein” refers to proteins having a degree of hydrolysis of less than 25%, including less than 20%, including less than 15%, including less than 10%, and including proteins having a degree of hydrolysis of less than 5%. The degree of hydrolysis is the extent to which peptide bonds are broken by a hydrolysis chemical reaction. To quantify the partially hydrolyzed protein component of these embodiments, the degree of protein hydrolysis is determined by quantifying the amino nitrogen to total nitrogen ratio (AN/TN) of the protein component of the selected nutritional powder. The amino nitrogen component is quantified by USP titration methods for determining amino nitrogen content, while the total nitrogen component is determined by the Tecator® Kjeldahl method. These analytical methods are well known.

In certain embodiments, the nutritional composition, the nutritional powder, or both includes a carbohydrate or a source of carbohydrate. The carbohydrate or source of carbohydrate suitable for use in the nutritional powders disclosed herein may be simple, complex, or variations or combinations thereof. Generally, the carbohydrate may include any carbohydrate or carbohydrate source that is suitable for use in oral nutritional compositions and is otherwise compatible with any other selected ingredients or features in the nutritional powder. It should be noted, however, it has been discovered that certain carbohydrates, when used at high concentrations, may be unsuitable for the nutritional powders of the present disclosure, because these carbohydrates may cause plugging in the beverage production machine. For example, it has been found that nutritional powders containing some types of rice starch at a concentration of about 15% or more of the total weight of the nutritional powder are more prone to plugging the beverage production machine, and therefore should be avoided.

Non-limiting examples of carbohydrates suitable for use in the nutritional powders described herein include, but are not limited to, polydextrose, maltodextrin; hydrolyzed or modified starch or cornstarch; glucose polymers; corn syrup; corn syrup solids; rice-derived carbohydrate; sucrose; glucose; fructose; lactose; high fructose corn syrup; honey; sugar alcohols (e.g., maltitol, erythritol, sorbitol); isomaltulose; sucromalt; pullulan; potato starch; and other slowly-digested carbohydrates; dietary fibers including, but not limited to, fructooligosaccharides (FOS), galactooligosaccharides (GOS), oat fiber, soy fiber, gum arabic, sodium carboxymethylcellulose, methylcellulose, guar gum, gellan gum, locust bean gum, konjac flour, hydroxypropyl methylcellulose, tragacanth gum, karaya gum, gum acacia, chitosan, arabinogalactans, glucomannan, xanthan gum, alginate, pectin, low methoxy pectin, high methoxy pectin, cereal beta-glucans (e.g., oat beta-glucan, barley beta-glucan), carrageenan and psyllium, digestion resistant maltodextrin (e.g., Fibersol™, a digestion-resistant maltodextrin, comprising soluble dietary fiber); soluble and insoluble fibers derived from fruits or vegetables; other resistant starches; and combinations thereof. The nutritional powders described herein may include any individual source of carbohydrate or combination of the various sources of carbohydrate listed above.

In certain embodiments, the nutritional composition, the nutritional powder, or both includes a fat or a source of fat. The fat or source of fat suitable for use in the nutritional powders described herein may be derived from various sources including, but not limited to, plants, animals, and combinations thereof. Generally, the fat may include any fat or fat source that is suitable for use in oral nutritional compositions and is otherwise compatible with any other selected ingredients or features in the nutritional powder. Non-limiting examples of suitable fat (or sources thereof) for use in the nutritional powders disclosed herein include coconut oil, fractionated coconut oil, soy oil, high oleic soy oil, corn oil, olive oil, safflower oil, high oleic safflower oil, medium chain triglyceride oil (MCT oil), high gamma linolenic (GLA) safflower oil, sunflower oil, high oleic sunflower oil, palm oil, palm kernel oil, palm olein, canola oil, high oleic canola oil, marine oils, fish oils, algal oils, borage oil, cottonseed oil, fungal oils, eicosapentaenoic acid (EPA), docosahexaenoic acid (DHA), arachidonic acid (ARA), conjugated linoleic acid (CLA), alpha-linolenic acid, rice bran oil, wheat bran oil, interesterified oils, transesterified oils, structured lipids, and combinations thereof. Generally, the fats used in nutritional powders for formulating infant formulas and pediatric formulas provide fatty acids needed both as an energy source and for the healthy development of the infant, toddler, or child. These fats typically comprise triglycerides, although the fats may also comprise diglycerides, monoglycerides, and free fatty acids. Fatty acids provided by the fats in the nutritional powder include, but are not limited to, capric acid, lauric acid, myristic acid, palmitic acid, palmitoleic acid, stearic acid, oleic acid, linoleic acid, alpha-linolenic acid, ARA, EPA, and DHA. The nutritional powders can include any individual source of fat or combination of the various sources of fat listed above.

### Optional Ingredients

In certain embodiments, the nutritional composition, the nutritional powder, or both described herein may further comprise other optional ingredients that may modify the physical, chemical, hedonic, or processing characteristics of the products or serve as additional nutritional components when used for a targeted population. Many such optional ingredients are known or otherwise suitable for use in other nutritional products and may also be used in the nutritional powders described herein, provided that such optional ingredients are safe and effective for oral administration and are compatible with the essential and other ingredients in the selected product form.

Non-limiting examples of such optional ingredients include preservatives, antioxidants, emulsifying agents, buffers, additional nutrients as described herein, colorants, flavors (natural, artificial, or both), thickening agents, flow agents, anti-caking agents, and stabilizers.

In certain embodiments, the nutritional composition, the nutritional powder, or both further comprises minerals, non-limiting examples of which include calcium, phosphorus, magnesium, iron, zinc, manganese, copper, sodium, potassium, molybdenum, chromium, selenium, chloride, and combinations thereof.

In certain embodiments, the nutritional composition, the nutritional powder, or both further comprises vitamins or related nutrients, non-limiting examples of which include vitamin A, vitamin D, vitamin E, vitamin K, thiamine, riboflavin, pyridoxine, vitamin B12, niacin, folic acid, pantothenic acid, biotin, vitamin C, choline, inositol, salts and derivatives thereof, and combinations thereof.

In certain embodiments, the nutritional composition, the nutritional powder, or both includes one or more masking agents to reduce or otherwise obscure bitter flavors and after taste. Suitable masking agents include natural and artificial sweeteners, natural and artificial flavors, sodium sources such as sodium chloride, and hydrocolloids, such as guar gum, xanthan gum, carrageenan, gellan gum, and combinations thereof. Generally, the amount of masking agent in the nutritional powder may vary depending upon the particular masking agent selected, other ingredients in the nutritional powder, and other nutritional powder or product target variables. Such amounts, however, most typically range from at least 0.1 weight %, including from about 0.15 weight % to about 3 weight %, and also including from about 0.18 weight % to about 2.5 weight %, by weight of the nutritional powder.

In certain embodiments, the nutritional powders include at least one wetting agent. Generally, wetting agents act to improve and hasten the interaction between the nutritional powder and the impinging liquid, typically water, supplied by the beverage production machine. The wetting agent thus assists in quickly reconstituting the nutritional powder into a suitable liquid product. Suitable wetting agents include phospholipids, mono- and di-glycerides, diacetyl tartaric acid ester of mono- and diglycerides (DATEM), mono- and diglyceride oil, and other emulsifiers and surfactants.

In certain embodiments, the nutritional powders include at least one anti-caking agent. Generally, these agents help to maintain the powder particles as loose, free-flowing particles with a reduced tendency to clump as the powder sits over time. Suitable anti-caking agents include silicon dioxide.

In certain embodiments, the nutritional composition, the nutritional powder, or both comprises a compound selected from the group of leucine, beta-alanine, epigallocatechin gallate, human milk oligosaccharides, prebiotics, probiotics, nucleotides, nucleosides, carotenoids (e.g., lutein, beta-carotene, lycopene, zeaxanthin), beta-hydroxy-beta-methylbutyrate (HMB), and combinations thereof. Although calcium HMB monohydrate is the preferred source of HMB for use herein, other suitable sources may include HMB as the free acid, a salt, an anhydrous salt, an ester, a lactone, or other product forms that otherwise provide a bioavailable form of HMB from the nutritional product.

### Methods of Use

In certain embodiments, an individual consumes one or more servings of the liquid product made using the nutritional powder pods in a beverage production machine. The serving size may be different for different types of individuals, depending on one or more factors including, but not limited to, age, body mass, gender, species, or health.

In these embodiments, an individual desirably consumes at least one serving of the liquid product made using the nutritional powder pods per day, and in some embodiments, may consume two, three, or even more servings per day. Each serving is desirably administered as a single undivided dose, although the serving may also be divided into two or more partial or divided servings to be taken at two or more times during the day.

The methods of the present disclosure include continuous day after day administration, as well as periodic or limited administration, although continuous day after day administration is generally desirable. The liquid product made using the nutritional powder pods may be used by infants, toddlers, children, and adults.

### Test Methods

Unless otherwise indicated herein, the following test methods describe the analytical methods and associated equipment used to determine the parameters and properties associated with the nutritional powder pods disclosed herein.

### Nutritional Powder Reconstitution Test

Generally, a nutritional powder reconstitution test can be used to evaluate how thoroughly the nutritional powder is reconstituted under the operating conditions of a beverage production machine, and to determine a corresponding reconstitution rate.

According to this test, multiple same size portions (e.g., triplicate portions of 2-5 g samples) are taken from the same batch of the nutritional powder to be tested. These portions are weighed both before and after drying by conventional drying techniques (e.g., convection or infrared) to determine the initial moisture content of each portion (i.e., the weight lost to drying). The average initial moisture content (by weight) is then determined by averaging the results from the multiple portions.

Preweighed portions of each test sample of the nutritional powder are enclosed in resealable nutritional powder pods for the reconstitution testing. Example amounts of the test samples of the nutritional powder range from 2-150 grams.

The test system may be a working beverage production machine, or a model system configured to simulate a beverage production machine and operating under specified conditions. The test system is configured to accommodate and operate under the operating conditions of a beverage product machine, as follows. The pressure within the pod, as well as the temperature of the water that contacts the nutritional powder and the amount of water flowing through the pod are controlled and measurable. For this test, the pod containing the test sample of the nutritional powder is inserted into the test system, and the system is set to deliver a certain amount of water (e.g., about 25-500 mL) at a certain temperature (e.g., in the range of 5-50° C.) under a certain pressure (e.g., 0.5-15 bar, or approximately 7-217 psia) into and through the pod. Under this test, the ratio of powder weight (grams) to water weight (grams) (where the density of water is taken to be 1 g/mL) is lower than 1:1 (e.g., 1:1.1, 1:1.2, 1:1.3, 1:2, 1:3, 1:5, etc.). In other words, relatively less powder (in grams) is used as compared to the amount (in grams) of water. A sufficiently large collection bottle is placed under the dispenser of the test system to receive the homogeneous liquid product output. The test system is started, and the homogeneous liquid product is collected in the collection bottle.

### Reconstitution Time

During the nutritional powder reconstitution test, described above, the reconstitution time is determined by measuring the time that elapses from the initiation time until the reconstituted product is observed to be fully delivered to the collection bottle.

### Rate of Reconstitution

The rate of reconstitution is determined using the general test method and system for the Nutritional Powder Reconstitution Test described above, except that the reconstituted liquid product is collected over 5-second intervals in sequentially-numbered collection vessels. The mass of collected powder in the reconstituted liquid product in each collection vessel is measured using any standard drying technique (e.g., forced air oven, infrared heating, microwave drying, etc.) to remove the water from the collected reconstituted liquid product. The rate of reconstitution is then determined by dividing the weight of total reconstituted solids, i.e., the mass of collected powder (milligram) by the original mass of nutritional powder in the pod (gram) and the collection time interval (seconds), thereby resulting in a “milligram/gram-second” value.

### Reconstitution Yield

The reconstitution yield is determined by measuring the residual powder in the pod after the general test method and system described for the Nutritional Powder Reconstitution Test described above is completed. A known amount of water is dispensed into the pod and mixed with the remaining powder which is emptied into a collection vessel. The total solids of this rinse water is measured using any standard drying technique (e.g., via a forced air oven or microwave drying technique) to remove the water from the product.

To determine the powder remaining in the pod, the grams of total solids in the rinse water are divided by the percentage of total solids in the powder. The reconstitution yield is then determined by subtracting the ratio of powder remaining in the pod to powder put in the pod from 1. The reconstituted yield can be reported in the units of “milligram/milligram” (mg/mg) or converted to a percentage (e.g., milligram/milligram X 100%).

### Mercury Porosimetry Test

Mercury porosimetry is used to measure the envelope powder volume, the powder porosity, and the open pore volume of the particles of the nutritional powder. The method used is as follows. Unless otherwise indicated herein, a Micromeritics Autopore IV porosimeter is used herein to determine the porosity. A sample of the powder to be tested is placed in a sample cup that is capable of being sealed and placed under vacuum. The sample cup is then evacuated under a vacuum to remove adsorbed gases and moisture from the sample. Liquid mercury is then fed into the sample cup through a capillary. The mercury is then slowly pressurized through the capillary to compress the powder and force the mercury into interstitial void volume and the open pores of the sample powder particles. The volume of mercury being forced into the sample is monitored as a function of pressure, because the mercury is forced into increasingly smaller voids and pores as the pressure increases. The volume of mercury released from the pores as the pressure is decreased may also be determined. Data from a pressure-volume curve can be used to quantify the envelope powder volume, the interstitial void volume, and the open pore volume of the particles, as well as the pore size distribution for the powder particles. The powder porosity is calculated as:

$$\frac{[ Interstitial void volume ] + [ Open pore volume ]}{Envelope powder volume} \times 100 = \% powder porosity$$

### Particle Size and Particle Size Distribution by Laser Diffraction

Laser diffraction is used to measure the particle size and particle size distribution for the nutritional powder disclosed herein. The powder is dispersed into an air stream and passed through a laser beam. The particles diffract the photons of the laser at different angles, depending on the size of the particle. A detector with semicircular ring elements detects the diffracted photons. The intensity of the detected photons and the angle of detection are used to calculate the number, area, and volume-weighted particle size in the sample. A particle size distribution is then determined from this information. From this distribution, a mean particle size, based on the number, area, or volume of particles, is then determined.

### Static Image Analysis

Static image analysis using a Malvern Morphologi G3 particle characterization system is used to measure the aspect ratio, circular equivalent diameter, and circularity for the nutritional powder disclosed herein. This system measures the size and shape of particles via static image analysis operating at 5× magnification. This system captures images of individual particles by scanning the sample underneath the microscope optics, while keeping the particles in focus. The data obtained is used to determine the aspect ratio, circular equivalent diameter, and circularity of the powder.

### Surface Area

The surface area of the particles of the nutritional powder disclosed herein is measured according to the BET multilayer gas adsorption method used by the TriStar II 3020 surface area and porosity analyzer (using Krypton option) made by a Micromeritics (Norcross, Ga., USA).

### Wettability

The wettability of the particles of the nutritional powder disclosed herein is measured according to the method described above. In particular, this method includes adding the nutritional powder to the surface of water in a container (e.g., a beaker) and recording the time it takes for the nutritional powder to fall below the surface.

### Dispersibility

The dispersibility of the particles of the nutritional powder disclosed herein is measured according to the method described above, in particular, by counting the total number of particles sieved and measuring the size of each particle, clump, or agglomeration from a reconstituted liquid from the nutritional powder pods disclosed herein that does not pass through the 80 mesh sieve using a millimeter measuring stick.

### EXAMPLES

Examples 1-3 demonstrate exemplary embodiments of the nutritional powders described herein. The exemplary embodiments are provided solely for the purpose of illustration and are not to be construed as limitations of the present disclosure, as many variations thereof are possible without departing from the spirit and scope of the present disclosure. The exemplary nutritional powders are prepared in accordance with the methods described herein.

Example 1A shown in Table 3 illustrates an exemplary nutritional powder that is formulated as an infant formula. All ingredient amounts are listed as pounds (lb) per 1,000 lb batch of nutritional powder.

TABLE 3

| | Example 1A |
|---|---|
| Ingredients | (Quantity (lb) per 1,000 lb batch) |
| Lactose | 388.31 |
| Non-Fat Dry Milk | 203.16 |
| High Oleic Safflower Oil | 115.89 |
| Soy Oil | 88.04 |
| Coconut Oil | 81.09 |
| Galactooligosaccharides | 66.87 |
| Whey Protein Concentrate | 50.00 |
| Potassium Citrate | 9.16 |
| Lecithin | 5.00 |
| Calcium Carbonate | 4.03 |
| Arachidonic Acid | 3.69 |
| Potassium Chloride | 1.25 |
| Docosahexaenoic Acid | 1.11 |
| Magnesium Chloride | 1.03 |
| Sodium Chloride | 0.59 |
| Choline Chloride | 0.43 |
| Vitamin ADEK | 0.39 |
| Ascorbyl Palmitate | 0.37 |
| Mixed Carotenoid Premix | 0.35 |
| Mixed Tocopherols | 0.16 |
| Ascorbic Acid | 1.27 |
| Riboflavin | 0.003 |
| L-Carnitine | 0.026 |
| Vitamin/Mineral Premix | 1.11 |
| Ferrous Sulfate | 0.45 |
| Nucleotide/Choline Premix | 2.33 |

Example 1B shown in Table 4 illustrates an exemplary nutritional powder that is formulated as a soy-protein containing infant formula. All ingredient amounts are listed as kilogram (kg) per 1,000 kg batch of nutritional powder.

TABLE 4

| | |
|---|---|
| | Example 1B |
| Ingredient | (Quantity (kg) per 1,000 kg batch) |

| Corn Syrup | 504.1 | |
|---|---|---|
| Soy Protein Isolate (5% DH) | 144.8 | |
| Sunflower Oil | 112.5 | |
| Sucrose | 98.3 | |
| Soy Oil | 83.9 | |
| Coconut Oil | 75.6 | |
| Fructooligosaccharides | 17 | |
| Potassium Citrate | 16.5 | |
| Calcium Phosphate | 16.4 | |
| Sodium Chloride | 3.8 | |
| Arachidonic Acid Oil | 3 | |
| Magnesium Chloride | 2.8 | |
| L-Methionine | 1.7 | |
| Ascorbic Acid | 1.1 | |
| Docosahexaenoic Acid Oil | 1.1 | |
| Lutein | 945.0 | mg |
| Choline Chloride | 507.7 | g |
| Taurine | 457.5 | g |
| Inositol | 353.0 | g |
| Ascorbyl Palmitate | 347.5 | g |
| Ferrous Sulfate | 319.2 | g |
| Mixed Tocopherols | 157.2 | g |
| L-Carnitine | 112.7 | g |
| Niacinamide | 97.9 | g |
| D-Alpha-Tocopheryl Acetate | 78.8 | g |
| Calcium D-Pantothenate | 58.7 | g |
| Zinc | 56.0 | g |
| Iron | 16.9 | g |
| Thiamine | 15.2 | g |
| Vitamin A Palmitate | 14.8 | g |
| Copper | 7.2 | g |
| Riboflavin | 6.7 | g |
| Pyridoxine Hydrochloride | 6.1 | g |
| Folic Acid | 2.1 | g |
| Potassium Iodide | 1.1 | g |
| Phylloquinone | 857.1 | mg |
| Vitamin D3 | 47 | mg |
| Lycopene | 980.0 | mg |
| Biotin | 592.5 | mg |
| Beta-Carotene | 215.6 | mg |
| Selenium | 147.0 | mg |
| Cyanocobalamin | 71.3 | mg |

Example 2 shown in Table 5 illustrates an exemplary nutritional powder that is formulated as a pediatric formula. All ingredient amounts are listed as kilogram (kg) per 1,000 kg batch of nutritional powder.

TABLE 5

| | Example 2 | |
|---|---|---|
| Ingredients | (Quantity (kg) per 1,000 kg batch) | |
| Maltodextrin | 300.0 | |
| Sucrose | 288.0 | |
| Milk Protein Concentrate (80%) | 121.1 | |
| Soy Oil | 82.0 | |
| High Oleic Sunflower Oil | 69.5 | |
| Whey Protein Concentrate | 27.9 | |
| MCT Oil | 26.7 | |
| Soy Protein Isolate | 24.4 | |
| Fructooligosaccharides | 22.9 | |
| Potassium Citrate | 7.1 | |
| Flavor | 6.7 | |
| Magnesium Phosphate Dibasic | 5.7 | |
| Potassium Chloride | 4.3 | |
| Sodium Chloride | 3.7 | |
| Tricalcium Phosphate | 3.2 | |
| Vitamin/Mineral Premix | 2.5 | |
| Docosahexaenoic Acid | 2.0 | |
| Choline Chloride | 1.7 | |
| Potassium Phosphate Monobasic | 1.5 | |
| Calcium Carbonate | 1.4 | |
| Potassium Phosphate Dibasic | 1.2 | |
| Ascorbic Acid | 871.7 | grams |
| Arachidonic Acid | 645.0 | grams |
| Ascorbyl Palmitate | 502.1 | grams |
| Vitamin ADEK Premix | 176.5 | grams |
| Lactobacillus Acidophilus | 100.0 | grams |
| Tocopherol Antioxidant | 83.7 | grams |
| dl-Alpha Tocopheryl Acetate | 49.5 | grams |
| Bifidobacterium Lactis | 35.0 | grams |
| Vitamin A Palmitate | 1.2 | grams |
| Potassium Iodide | 89.2 | milligrams |

| | |
|---|---|
| Sodium Citrate | As Needed |
| Magnesium Chloride | As Needed |
| Citric Acid (processing aid) | As Needed |
| Potassium Hydroxide (processing aid) | As Needed |

Example 3 shown in Table 6 illustrates an exemplary nutritional powder that is formulated as an adult nutritional product. All ingredient amounts are listed as kilogram (kg) per 1,000 kg batch of nutritional powder.

TABLE 6

| | Example 3 | |
|---|---|---|
| Ingredients | (Quantity (kg) per 1,000 kg batch) | |
| Maltodextrin | 268.7 | |
| Corn Syrup Solids | 192.7 | |
| Milk Protein Concentrate (80%) | 133 | |
| Sucrose | 112.4 | |
| High Oleic Sunflower Oil | 85.3 | |
| Soy Oil | 38.5 | |
| Soy Protein Isolate | 54.7 | |
| Fructooligosaccharides | 21.9 | |
| Inulin | 21.9 | |
| Canola Oil | 13.8 | |
| Sodium Citrate | 12.8 | |
| Potassium Citrate | 11.7 | |
| Flavor | 7.3 | |
| Magnesium Chloride | 6.3 | |
| Potassium Chloride | 4.2 | |
| Tricalcium Phosphate | 3.5 | |
| Choline Chloride | 1.7 | |
| Ascorbic Acid | 880.0 | grams |
| Calcium Carbonate | 553.0 | grams |
| Water Soluble Vitamin Premix | 485.0 | grams |
| Ultra Trace Mineral/Trace | 430.0 | grams |
| Mineral Premix | | |
| Ascorbyl Palmitate | 164.6 | grams |
| Vitamin AEDK Premix | 146.7 | grams |
| Tocopherol Antioxidant | 82.3 | grams |
| dl-Alpha Tocopheryl Acetate | 44.7 | grams |
| Beta Carotene (30%) | 5.5 | grams |
| Manganese Sulfate | 3.7 | grams |
| Thiamin Hydrochloride | 2.5 | grams |
| Riboflavin | 1.5 | grams |
| Vitamin A Palmitate | 1.2 | grams |
| Potassium Iodide | 913.3 | milligrams |

| | |
|---|---|
| Magnesium Sulfate | As Needed |
| Copper Sulfate | As Needed |
| Citric Acid (processing aid) | As Needed |
| Potassium Hydroxide (processing aid) | As Needed |

Examples 4-10 illustrate certain physical properties or characteristics of exemplary nutritional powders of the present disclosure. The nutritional powders were produced using extrusion according to the methods described above. The nutritional powders included infant, toddler, and adult formulations. Example 4 was an infant formula powder with a formulation similar to the formulation given in Table 3 above. Example 7, like the formulation given in Table 4 above, was an infant formula powder containing soy protein. Example 9 was a pediatric formula nutritional powder with a formulation similar to the formulation given in Table 5 above. Example 10 was an adult nutritional powder with a formulation similar to the formulation given in Table 6 above.

The exemplary nutritional powders of Examples 4-10 were tested to determine the mean particle size and particle size distribution in accordance with the laser diffraction test method described above. The results of such testing are shown in Table 7.

TABLE 7

| | | Mean | Particle Size Distribution (μm) | |
|---|---|---|---|---|
| | | Particle Size | 10^{th} | 90^{th} |
| Example | Sample Code | (μm) | percentile** | percentile*** |
| Example 4 | 3B | 334 | 50 | 500 |
| Example 5 | 4B | 273 | 61 | 541 |
| Example 6 | 5B | 164 | 36 | 348 |
| Example 7 | 6B | 173 | 46 | 339 |
| Example 8 | 7B | 179 | 30 | 391 |
| Example 9 | 8B | 176 | 39 | 375 |
| Example 10 | 9B | 379 | 61 | 777 |

**10% of the particles of the nutritional powder were larger than the listed particle size.
***90% of particles of the nutritional powder were smaller than the listed particle size.

The nutritional powders of Examples 4-10 each had a mean particle size ranging from about 164 μm to about 379 μm. The mean particle size for Examples 4-10 together was about 240 μm.

The exemplary nutritional powders of Examples 4-10 were also tested to determine the wettability in accordance with the test method previously described. Specifically, the wettability of the nutritional powder was measured by adding a level teaspoon of the nutritional powder to the surface of 100 mL of water in a 250 mL glass beaker, and recording the time it took for the nutritional powder to fall below the surface of the water. The results of the wettability testing are shown in Table 8.

TABLE 8

| Example | Sample Code | Wettability (seconds) |
|---|---|---|
| Example 4 | 3B | >120 |
| Example 5 | 4B | >120 |
| Example 6 | 5B | >120 |
| Example 7 | 6B | >120 |
| Example 8 | 7B | >120 |
| Example 9 | 8B | 6 |
| Example 10 | 9B | >120 |

As seen in Table 8, the nutritional powders of Examples 4-10 had a wettability ranging from about 6 seconds to over 120 seconds (the test stopped timing at 120 seconds). The average wettability for Examples 4-10 was at least about 104 seconds based on the recorded times.

The reconstitution time, reconstitution yield, and rate of reconstitution of the nutritional powders of Examples 5-8 were measured according to the test methods previously described. The results are given in Table 9.

TABLE 9

| | Sample | Reconstitution | Reconstitution | Reconstitution Rate (mg/g-sec) | | | |
|---|---|---|---|---|---|---|---|
| Example | Code | Time (sec) | Yield (%) | beginning | after 15 sec | after 30 sec | end |
| Example 5 | 4B | 45 | 99.3 | 13 | 1.0 | 0.5 | 0.1 |
| Example 6 | 5B | 40 | 98.7 | 8 | 3.0 | 0.6 | 0.1 |
| Example 7 | 6B | 40 | 98.9 | 16 | 1.2 | 1.1 | 0.2 |
| Example 8 | 7B | 45 | 99.0 | 12 | 0.3 | 1.2 | 0.1 |

As seen in Table 9, the exemplary nutritional powders of Examples 5-8 had reconstitution times ranging from about 40 seconds to about 45 seconds, with an average reconstitution time of about 42.5 seconds. The reconstitution yield of the tested nutritional powders ranged from about 98.7% to about 99.3%, with an average reconstitution yield of about 99%.

The dispersibility of the nutritional powders of Examples 5-8 were also tested in accordance with the test method previously described. The results of the dispersibility testing are shown in Table 10.

TABLE 10

| | | # Particles | # Particles | # Particles |
|---|---|---|---|---|
| Example | Sample Code | ≦1 mm | 2-4 mm | ≧5 mm |
| Example 5 | 4B | 279 | 1 | 0 |
| Example 6 | 5B | 40 | 0 | 0 |
| Example 7 | 6B | 87 | 3 | 0 |
| Example 8 | 7B | 26 | 10 | 0 |

As seen in Table 11, the nutritional powders of Examples 5-8 had a total number of particles less than or equal to 1 mm within a range of about 26 particles to about 279 particles, with an average number of particles less than or equal to 1 mm of about 108. The nutritional powders of Examples 5-8 had a total number of particles that were from 2 mm to 4 mm within a range of about 1 particles to about 10 particles, with an average number of particles from 2 mm to 4 mm of about 4. None of the nutritional powders of Examples 5-8 had particles that were greater than or equal to 5 mm. As discussed above, a smaller number of undissolved particles correlates to a better dispersibility.

### Comparison of Extruded Powder and Spray Dried Powder

A study was carried out to compare the physical and reconstitution properties and characteristics of the extruded powder of Example 7 to that of a spray dried powder (“Comparative Example”) with the same formulation. Thus, the main difference between the powder of Example 7 and the Comparative Example was the preparation technique. The powders of Example 7 and the Comparative Example contain the following primary ingredients shown in Table 11.

TABLE 11

| | Amount in kg per |
|---|---|
| Ingredients | 1000 kg |
| Corn Syrup | 508 |
| Soy Protein Isolate | 146 |
| High Oleic Safflower Oil | 115 |
| Sucrose | 99 |
| Soy Oil | 84 |
| Coconut oil | 77 |

The remaining ingredients not shown in Table 11 for Example 7 and the Comparative Example include oils, carbohydrates, vitamins, minerals, processing aids (e.g., emulsifiers) and other minor ingredients that each amount to less than 0.5% by weight of the total composition. For Example 7, the nutritional powder was prepared in the following manner. In a continuous process, soy protein isolate and corn syrup solids were metered into the first barrel of a twin screw extruder through a gravimetric powder feed system where it was compounded with water until hydrated at a temperature of 70° C. The hydrated mixture passed from the first section of the extruder into the center section. Coconut, high oleic safflower, and soy oils were injected into the extruder in the center processing section at a temperature of 70° C. to form an emulsion. The remainder of the ingredients were added into the last section of the extruder and heated to 95° C. for micro reduction control. The residence time inside the extruder was 2 minutes or less. The wet extrudate emulsion flowed out of the extruder and into a dryer where the remainder moisture was removed and solid pellets were formed. The dryer had 6 heating zones that ranged in temperature from 160° C., 150° C., 140° C., 130° C., 100° C., and 50° C. The residence time within the dryer was up 10-30 min, nominally 20 min. Dried pellets were formed and exited the dryer. The pellets were milled with a mechanical mill to form a powder.

In contrast, the powder of the Comparative Example was prepared in the following manner: at least two separate slurries were prepared, including a protein-in-fat (PIF) slurry and a carbohydrate-mineral (CHO-MN) slurry. The PIF slurry was formed by heating and mixing the high oleic safflower oil, soy and coconut oils and then any oil soluble vitamins and at least a portion of the total protein (e.g., soy protein isolate) was added with continued heat and agitation. The CHO-MN slurry was formed by adding to water, with heat and agitation, minerals (e.g., potassium citrate, dipotassium phosphate, or sodium citrate), including trace minerals (TM) and ultra-trace minerals (UTM) (e.g., a TM/UTM premix). The resulting slurry was held with continued heat and agitation before additional minerals (e.g., potassium chloride, magnesium carbonate, or potassium iodide) and the carbohydrates (e.g., sucrose or FOS) were added to complete the CHO-MIN slurry. In accordance with this process, the two slurries were mixed together with heat and agitation to form a nutritional emulsion. Any remaining carbohydrates (e.g. corn syrup solids) and oils (e.g. DHA and ARA) were then added to the final nutritional emulsion. The pH of the nutritional emulsion was adjusted to the desired range, e.g., from 6.6 to 7.5 (including 6.6 to 7.0), after which the nutritional emulsion is subjected to high-temperature short-time (HTST) processing (i.e., about 165° F. (74° C.) for about 16 seconds) or an ultra-high temperature (UHT) processing step (i.e., about 292° F. (144° C.) for about 5 seconds). The nutritional emulsion was heat treated, emulsified, homogenized, and cooled during the HTST or UHT process. Water soluble vitamins and ascorbic acid were added (if applicable), and the pH was again adjusted (if necessary). The batch was evaporated (if applicable), heat treated and spray dried. The powder of the Comparative Example was tested in a pod in the same manner as that of Example 7.

Specifically, the reconstitution time, reconstitution yield, reconstitution rate, dispersibility, mean particle size, porosity, wettability, aspect ratio, circular equivalent diameter, and circularity of the Example 7 (if not discussed already) and Comparative Example were measured in accordance with the methods previously discussed herein. A comparison of these values determined for Example 7 and the Comparative Example are shown in Table 12.

TABLE 12

| Characteristic | Example 7 | Comparative Example |
|---|---|---|
| Reconstitution Time (seconds) | 40 | 40 |
| Rate of Reconstitution (mg/g-sec) | | |
| Beginning of Run | 16 | 16 |
| After 15 seconds | 1.2 | 1.2 |
| After 30 seconds | 1.1 | 1.1 |
| End of Run | 0.2 | 0.3 |
| Reconstitution Yield (%) | 98.9 | 98.9 |
| Dispersibility | | |
| # particles ≦1 mm | 3 | 15 |
| # particles 2-4 mm | 2 | 4 |
| # particles ≧5 mm | 0 | 0 |
| Mean Particle Size (μm) | 173 | 140 |
| Powder Porosity (%) | 60 | 54 |
| Wettability (sec) | >120 | 15 |
| Aspect Ratio | 0.74 | 0.84 |
| Circular Equivalent Diameter (μm) | 263 | 163 |
| Circularity | 0.89 | 0.93 |

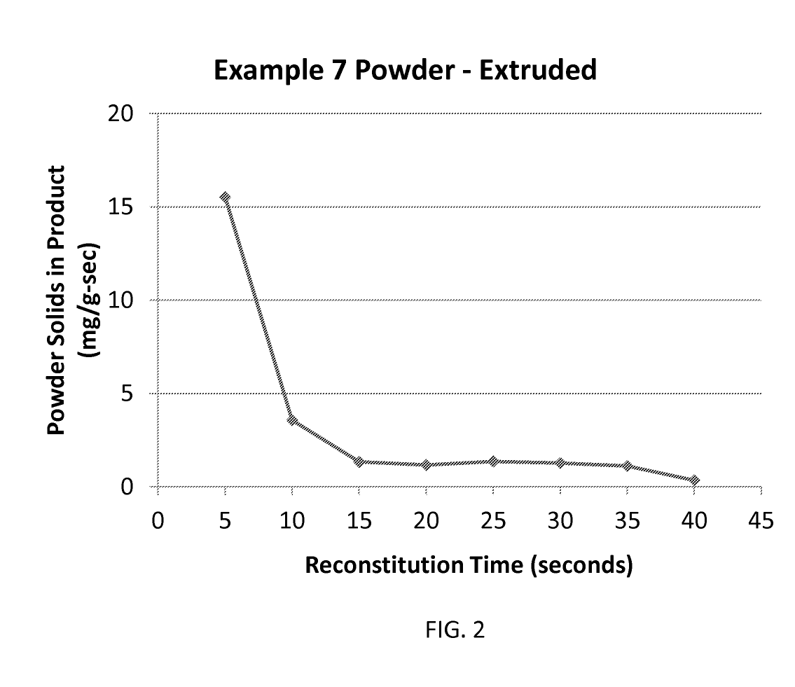

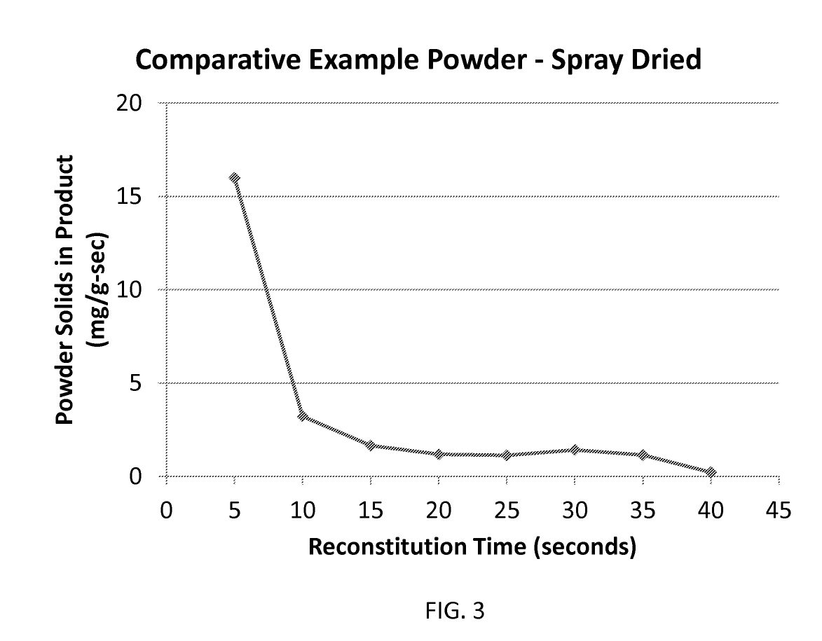

The reconstitution rate for Example 7 and the Comparative Example are shown in FIGS. 2-3. As can be appreciated from the reconstitution data provided in Table 12 and FIGS. 2-3, the reconstitution of the powder from the pod of Example 7 is substantially the same as that of the Comparative Example. However, although the reconstitution time, yield, and rate are effectively the same for Example 7 and the Comparative Example, the dispersibility of the powder of Example 7 is unexpectedly better than that of the Comparative Example. Specifically, there are 3 particles at less than or equal to 1 mm for Example 7 as compared to 15 particles for the Comparative Example. This is also notable and unexpected in view of the much higher wettability of the powder of Example 7 (>120 sec for Example 7 as compared to 15 seconds for the Comparative Example). The longer wettability time associated with the extruded powder (Example 7) would be expected to result in a longer reconstitution time and/or a lower reconstitution yield compared to the spray dried powders (Comparative Example) due to the fact that the longer wettability time indicates that more time is needed to fully reconstitute. Yet, the Example 7 powder exhibited a reconstitution time and a reconstitution yield similar to that of the Comparative Example powder.

Numerical ranges and parameters as used herein, including but not limited to percentages, parts and ratios, are intended to include every number, subset of numbers and sub-ranges within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All percentages, parts, and ratios as used herein are by weight of the total product, unless specified otherwise. All such weights as they pertain to listed ingredients are based on the active ingredients and, therefore, do not include solvents or by-products that may be included in commercially available materials, unless specified otherwise.

All references to singular characteristics or limitations of the present disclosure shall include the corresponding plural characteristic or limitation, and vice versa, unless otherwise specified or clearly implied to the contrary by the context in which the reference is made.

As used in the description of the invention and the appended claims, the singular forms “a,” “an,” and “the” are intended to include the plural forms as well, unless the context clearly indicates otherwise. To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

Unless otherwise indicated herein, all sub-embodiments and optional embodiments are respective sub-embodiments and optional embodiments to all embodiments described herein. While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus, and illustrative examples shown and described. Accordingly, departures may be made from such details without departing from the spirit or scope of the applicant's general disclosure herein.

1. A process for preparing a nutritional powder pod suitable for use in a beverage production machine, the process comprising:
extruding a nutritional composition in an extruder;
drying and milling the extruded nutritional composition to form a nutritional powder; and
packaging the nutritional powder in a pod to form the nutritional powder pod.

2. The process of claim 1, wherein the nutritional powder has a rate of reconstitution of from about 0.02 mg/g-sec to about 20 mg/g-sec.

3. The process of claim 1, wherein the nutritional powder comprises particles having at least one of a flake, spheroidal, cuboidal, plate, rod, and thread shape.

4. The process of claim 1, wherein the nutritional powder comprises a majority of particles having a non-spheroidal shape.

5. The process of claim 1, wherein the nutritional powder comprises particles having a surface area between about 0.02 m²/g and about 3 m²/g.

6. The process of claim 1, wherein the nutritional powder comprises particles having a circular equivalent diameter of from about 0.5 μm to about 1000 μm.

7. The process of claim 1, wherein the nutritional powder comprises particles having an aspect ratio between about 0.1 and about 1.

8. The process of claim 1, wherein the nutritional powder has a water activity level of about 0.1 to about 0.5.

9.-19. (canceled)

20. The process claim 1, further comprising agglomerating at least a portion of the nutritional powder.

21. (canceled)

22. The process of claim 1, wherein the nutritional powder is an infant formula, a pediatric formula, or an adult formula.

23-24. (canceled)

25. A nutritional powder pod for use in a beverage production machine made by the process of claim 1.

26. A nutritional powder pod comprising:
an extruded nutritional powder; and
a pod enclosing the extruded nutritional powder, wherein the pod is configured for use with a beverage production machine.

27. The nutritional powder pod of claim 26, wherein the extruded nutritional powder has a rate of reconstitution of from about 0.02 mg/g-sec to about 20 mg/g-sec.

28. The nutritional powder pod of claim 26, wherein the extruded nutritional powder comprises particles having at least one of a flake, spheroidal, cuboidal, plate, rod, and thread shape.

29. The nutritional powder pod of claim 26, wherein the extruded nutritional powder comprises a majority of particles having a non-spheroidal shape.

30. The nutritional powder pod of claim 26, wherein the extruded nutritional powder comprises particles having a circular equivalent diameter of from about 0.5 μm to about 1000 μm.

31. The nutritional powder pod of claim 26, wherein the extruded nutritional powder has a water activity level of about 0.1 to about 0.5.

32.-34. (canceled)

35. The nutritional powder pod of claim 26, wherein the extruded nutritional powder comprises a fat in an amount from about 10 weight % to about 40 weight % of the nutritional powder.

36. A package containing multiple nutritional powder pods according to claim 26.

37.-38. (canceled)

39. A kit comprising a beverage production machine and a nutritional powder pod according to claim 26.
